(19) United States
(12) Patent Application Publication
(10) Pub. No.: US 2025/0098030 A1
(43) Pub. Date: Mar. 20, 2025

(54) AUTOMATIC PUBLIC LAND MOBILE NETWORK SERVING SYSTEM RESELCTION BASED ON E911 PUBLIC ANSWER SAFETY POINT TERMINATION FAILURES

(71) Applicant: T-MOBILE INNOVATIONS LLC, Overland Park, KS (US)

(72) Inventors: Mark PEDEN, Paola, KS (US); Simon YOUNGS, Overland Park, KS (US); Thomas Michael KOCH, Olathe, KS (US); Raymond Emilio REEVES, Orlando, FL (US)

(21) Appl. No.: 18/369,692

(22) Filed: Sep. 18, 2023

(51) Int. Cl. H04W 76/50; H04W 48/02; H04W 84/04

(52) U.S. Cl. CPC H04W 76/50; H04W 48/02; H04W 84/042

(57) ABSTRACT

Systems and methods are provided for automatic PLMN serving system reselection based on E911 PSAP termination failures. For example, a UE may initiate a call for emergency services on a network provided by a cell site simulator. When the connection fails, metrics corresponding to the termination failure are communicated to the PLMN the next time the UE connects to a legitimate network. The fraudulent cell sites may be communicated by the UE to other UEs via peer-to-peer communication and/or added to an FPLMN list to prevent other UEs from connecting to networks provided by the fraudulent cell sites.

### SUMMARY

Embodiments of the technology described herein are directed to, among other things, systems and methods for automatic public land mobile network (PLMN) serving system reselection based on E911 public safety answer point (PSAP) termination failures. More particularly, fraudulent cell sites can be identified based on failed E911 calls. The fraudulent cell sites may be added to a forbidden public land mobile network (FPLMN) list to prevent other UEs from connecting to networks provided by the fraudulent cell sites. For example, user equipment (UE) may initiate a call for emergency services on a network provided by a cell site simulator. When the connection fails, metrics corresponding to the termination failure are communicated to the PLMN the next time the UE connects to a legitimate network.

In some aspects, the UE infers the cell site simulator is fraudulent and provides, via peer-to-peer communication to other UEs in proximity, an indication the cell site simulator is a fraudulent cell site. Additionally or alternatively, the PLMN utilizes the metrics to determine a probability score for the cell site simulator. Based on the probability score, the PLMN can determine the cell site simulator is a fraudulent site and communicate an updated FPLMN to the UE and other UEs in proximity.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present technology are described in detail herein with reference to the attached figures, which are intended to be exemplary and non-limiting, wherein:

FIG. 1 illustrates a diagram of an exemplary network environment in which implementations of the present disclosure may be employed;

FIG. 2 illustrates a diagram of a PLMN reselection engine, in accordance with aspects herein;

FIG. 3 is a flow diagram of an example method for automatic PLMN serving system reselection based on E911 PSAP termination failures, in accordance with some aspects of the technology described herein;

FIG. 4 is a flow diagram of an example method for automatic PLMN serving system reselection based on E911 PSAP termination failures, in accordance with some aspects of the technology described herein; and

FIG. 5 depicts an example computing environment suitable for use in implementation of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

Embodiments of the technology may take the form of, among other things: a method, system, or set of instructions embodied on one or more computer-readable media. Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

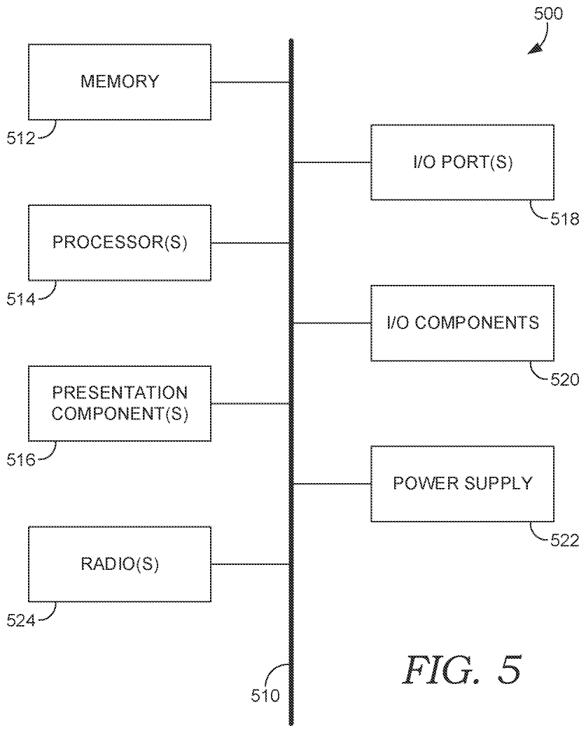

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 500 described herein with respect to FIG. 5.

Cell site simulators, also known as Stingrays or IMSI catchers, are devices that masquerade as legitimate cell sites to trick UEs in proximity into connecting to the cell site simulator, rather than a legitimate cell site. Law enforcement use cell site simulators to pinpoint the location of UEs with greater accuracy than a PLMN. Because UEs are designed to connect to the cell site with the strongest signal, cell site simulators exploit this design by broadcasting signals that are stronger than the legitimate cell sites in proximity. This causes UEs within range to disconnect from legitimate cell sites and establish a new connection with the cell site simulator. However, in situations where a UE is connected to a cell site simulator and attempts to make an E911 call, an unexpected PLMN used in the attach sequence results in a PSAP termination failure (or notification to the UE or tracking application that there is a mismatch with the home PLMN).

The present disclosure is directed to systems, methods, and computer readable media that systems and methods for automatic PLMN serving system reselection based on E911 PSAP termination failures. More particularly, fraudulent cell sites can be identified based on failed E911 calls. The fraudulent cell sites may be added to a FPLMN list to prevent other UEs from connecting to networks provided by the fraudulent cell sites. For example, a UE may initiate a call for emergency services on a network provided by a cell site simulator. When the connection fails, metrics corresponding to the termination failure are communicated to the PLMN the next time the UE connects to a legitimate network.

In some aspects, the UE infers the cell site simulator is fraudulent and provides, via peer-to-peer communication to other UEs in proximity, an indication the cell site simulator is a fraudulent cell site. Additionally or alternatively, the PLMN utilizes the metrics to determine a probability score for the cell site simulator. Based on the probability score, the PLMN can determine the cell site simulator is a fraudulent site and communicate an updated FPLMN to the UE and other UEs in proximity.

According to aspects of the technology described herein, a method for automatic PLMN serving system reselection based on E911 PSAP termination failures is provided. The method comprises attempting, at a UE, a connection to the PSAP. The method also comprises receiving, at the UE, an indication the connection to the PSAP failed. The method further comprises based on the indication, communicating metrics to the PLMN, the metrics corresponding to a cell site providing service to the UE while the UE attempted the connection to the PSAP.

According to further aspects of the technology described herein, a method for automatic PLMN serving system reselection based on E911 PSAP termination failures is provided. The method comprises receiving, at the PLMN, metrics from a UE indicating a connection to PSAP failed, the metrics corresponding to a cell site providing service to the UE while the UE attempted the connection to the PSAP. The method also comprises determining, at the PLMN, a probability score for the cell site corresponding to the metrics. The method further comprises, based on the probability score, determining the cell site is fraudulent.

According to even further aspects of the technology described herein, a system for PLMN serving system reselection based on E911 PSAP termination failures is provided. The system comprises a node configured to wirelessly communicate with UE. The system also comprises the UE configured to: attempt a connection to the PSAP; receive an indication the connection to the PSAP failed; and based on the indication, communicate metrics to the PLMN, the metrics corresponding to a cell site providing service to the UE while the UE attempted the connection to the PSAP.

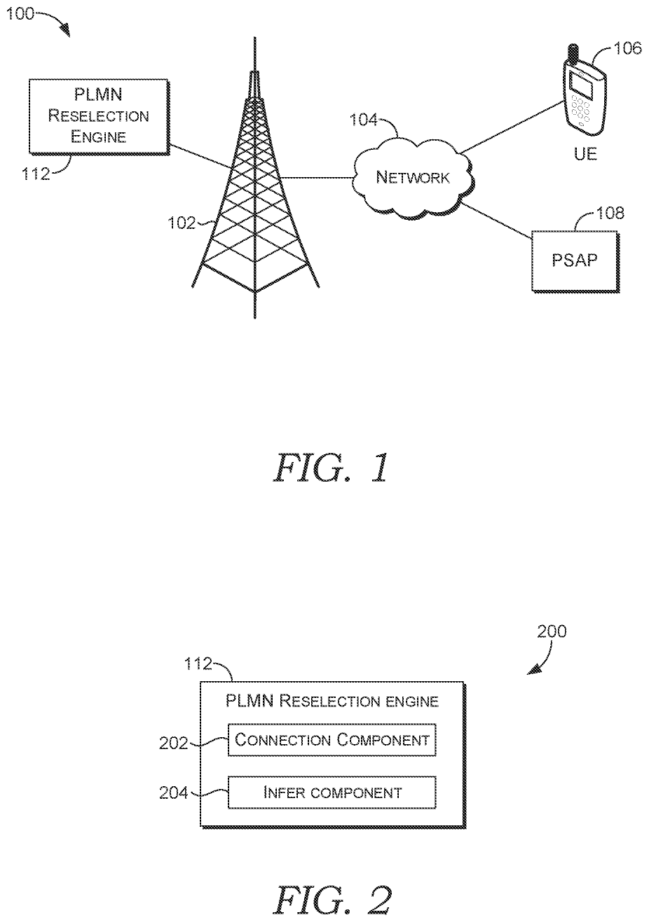

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network cell may comprise a base station to facilitate wireless communication between a communications device within the network cell, such as communications device 500 described with respect to FIG. 5, and a network. As shown in FIG. 1, a communications device may be a UE 106. In the network environment 100, UE 106 may communicate with other devices, such as mobile devices, servers, etc. The UE 106 may take on a variety of forms, such as a personal computer, a laptop computer, a tablet, a netbook, a mobile phone, a Smart phone, a personal digital assistant, or any other device capable of communicating with other devices. For example, the UE 106 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 106 comprises a wireless or mobile device with which a wireless telecommunication network(s) can be utilized for communication (e.g., voice and/or data communication). In this regard, the UE 106 can be any mobile computing device that communicates by way of, for example, a 5G network.

The UE 106 may utilize network 104 to communicate with other computing devices (e.g., mobile device(s), a server(s), a personal computer(s), etc.). In embodiments, network 104 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 104 may include multiple networks, as well as being a network of networks, but is shown in more simple form so as to not obscure other aspects of the present disclosure. Network 104 may be part of a telecommunications network that connects subscribers to their immediate service provider. In embodiments, network 104 is associated with a telecommunications provider that provides services to user devices, such as UE 106. For example, network 104 may provide voice services to user devices or corresponding users that are registered or subscribed to utilize the services provided by a telecommunications provider. It is contemplated network 104 can be any communication network providing voice and/or data service(s), such as, for example, a 1x circuit voice, a 3G network (e.g., CDMA, CDMA1000, WCDMA, GSM, UMTS), a 4G network (WiMAX, LTE, HSDPA), or the like.

The network environment 100 may include a database (not shown). The database may be similar to the memory component 512 in FIG. 5 and can be any type of medium that is capable of storing information. The database can be any collection of records (e.g., FPLMN list and/or metrics from UEs). In one embodiment, the database includes a set of embodied computer-executable instructions that, when executed, facilitate various aspects disclosed herein. These embodied instructions will variously be referred to as “instructions” or an “application” for short.

As previously mentioned, the UE 106 may communicate with other devices by using a base station, such as base station 102. In embodiments, base station 102 is a wireless communications station that is installed at a fixed location, such as at a radio tower, as illustrated in FIG. 1. The radio tower may be a tall structure designed to support one or more antennas for telecommunications and/or broadcasting. In other embodiments, base station 102 is a mobile base station. The base station 102 may be an MMU and include gNodeB for mMIMO/5G communications via network 104. In this way, the base station 102 can facilitate wireless communication between UE 106 and network 104.

As stated, the base station 102 may include a radio (not shown) or a remote radio head (RRH) that generally communicates with one or more antennas associated with the base station 102. In this regard, the radio is used to transmit signals or data to an antenna associated with the base station 102 and receive signals or data from the antenna. Communications between the radio and the antenna can occur using any number of physical paths. A physical path, as used herein, refers to a path used for transmitting signals or data. As such, a physical path may be referred to as a radio frequency (RF) path, a coaxial cable path, cable path, or the like.

The antenna is used for telecommunications. Generally, the antenna may be an electrical device that converts electric power into radio waves and converts radio waves into electric power. The antenna is typically positioned at or near the top of the radio tower as illustrated in FIG. 1. Such an installation location, however, is not intended to limit the scope of embodiments of the present invention. The radio associated with the base station 102 may include at least one transceiver configured to receive and transmit signals or data.

In practice, a user of a UE 106 may need emergency services. The user places a call to emergency services (e.g., 911) and the base station 102 facilitates wireless communication between UE 106 and PSAP 108 via the network. However, if a cell site simulator (not shown) is in proximity and broadcasting a stronger signal, the UE 106 will connect to the cell site simulator rather than the base station 102. In this scenario, a connection to the PSAP 108 fails. However, the UE retains metrics corresponding to the cell site simulator. The metrics may include received signal strength indicator (RSSI) values corresponding to the cell site simulator.

Continuing, the network environment 100 may further include a PLMN reselection engine 112. The PLMN reselection engine 112 may be configured to, among other things, identify fraudulent sites and communicate an updated FPLMN list to UEs in proximity, in accordance with the present disclosure. The PLMN reselection engine 112 may also be configured to, among other things, identify fraudulent sites and report associated information to a regulatory agency. Though PLMN reselection engine 112 is illustrated as a component of base station 102 in FIG. 1, it may be a standalone device (e.g., a server having one or more processors), a service provided via the 5G network 104, a component of the UE 106, or may be remotely located.

Referring now to FIG. 2, the PLMN reselection engine 112 may include, among other things, connection component 202 and infer component 204. The PLMN reselection engine 112 may receive, among other things, data from user devices, such as UE 106, or PSAP 108 within a network cell associated with a particular base station 102. Additionally or alternatively, the PLMN reselection engine 112 may receive, among other things, data from base station 102, such as data from a gNodeB or eNodeB or from a plurality of base stations.

Connection component 202 generally receives metrics from a UE corresponding to an E911 PSAP termination failure. The metrics may include RSSI values. For example, the metrics may indicate whether the connection between the UE and the cell site was strong enough to prevent a termination failure.

Infer component 204 generally determines a probability score for the cell site corresponding to the metrics. For example, if the connection between the UE and the cell site was not strong enough to prevent a termination failure, the probability score may reflect that it is unlikely, or at least indeterminate, the cell site is fraudulent. In contrast, if the connection between the UE and the cell site was strong and a termination failure should not have occurred, the probability score may reflect that is likely, or at least more likely, the cell site is fraudulent.

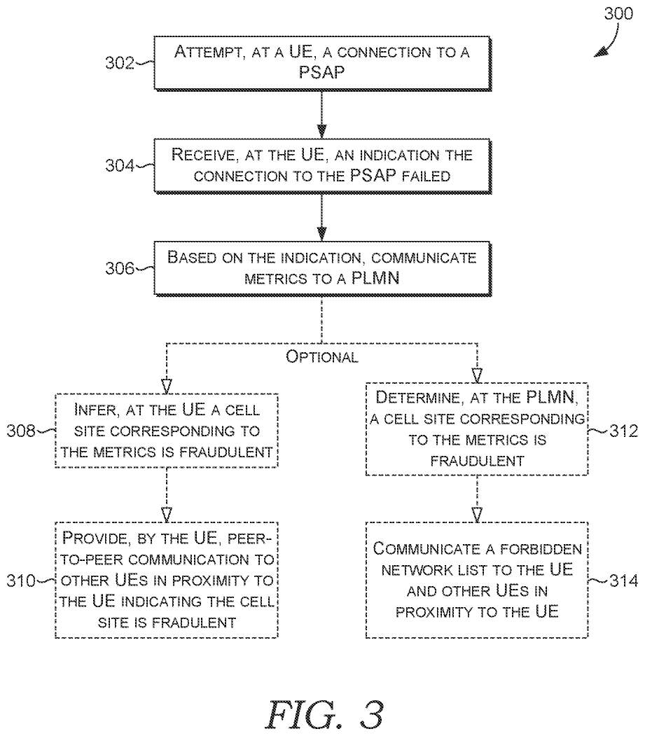

Referring to FIG. 3, a flow diagram is provided depicting a method for automatic PLMN serving system reselection based on E911 PSAP termination failures, according to aspects of the technology described herein. Method 300 may be performed by any computing device (such as computing device described with respect to FIG. 5) with access to an PLMN reselection engine (such as the one described with respect to FIGS. 1 and 2) or by one or more components of the network environment described with respect to FIG. 1 (such as UE 106, base station 102, or PLMN reselection engine 112). Initially, at 302, a UE attempts a connection to the PSAP.

At step 304, an indication is received at the UE indicating the connection to the PSAP failed. Based on the indication, at step 306, metrics are communicated to the PLMN the next time the UE connects to a legitimate cell site. For clarity, the metrics correspond to a cell site providing service to the UE while the UE attempted the connection to the PSAP. In some aspects, the metrics include RSSI values.

In some aspects, the UE may attempt additional connections to the PSAP until a threshold number of failed connections is reached. At step 308, the UE may infer the cell site is fraudulent. For example, the metrics may indicate the signal strength is high and the connection to the PSAP should not have failed. Accordingly, the UE can infer the cell site is fraudulent. Based on this inference, at step 310, the UE may provide peer-to-peer communication to other UEs in proximity to the UE indicating the cell site is fraudulent. The peer-to-peer communication may add the cell site to a forbidden network list (i.e., the FPLMN list) stored at the subscriber identity module (SIM) card corresponding to each of the UEs.

In some aspects, at step 312, the PLMN may determine a cell site corresponding to the metrics is fraudulent. Again, the metrics may indicate the signal strength is high and the connection to the PSAP should not have failed. Accordingly, the PLMN may determine the cell site is fraudulent. At step 314, a forbidden network list may be communicated to the UE and other UEs in proximity to the UE. The forbidden network list may be stored at a SIM card associated with the UE.

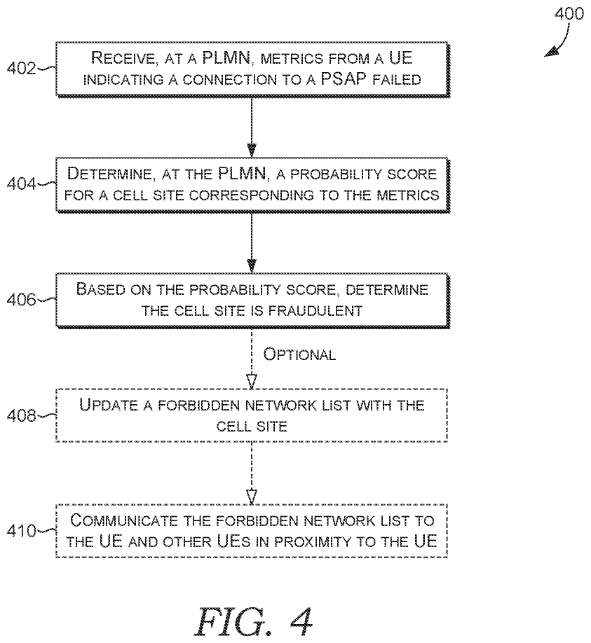

Turning now to FIG. 4, a flow diagram is provided depicting a method for automatic PLMN serving system reselection based on E911 PSAP termination failures, according to aspects of the technology described herein. Method 400 may be performed by any computing device (such as computing device described with respect to FIG. 5) with access to an PLMN reselection engine (such as the one described with respect to FIGS. 1 and 2) or by one or more components of the network environment described with respect to FIG. 1 (such as UE 106, base station 102, or PLMN reselection engine 112). Initially, although not shown by FIG. 4, a UE may attempt a connection to the PSAP. If the connection fails, the UE may collect metrics corresponding to a cell site providing service to the UE while the UE attempted the connection to the PSAP. In some aspects, the metrics include RSSI values. The UE communicates the metrics to the PLMN the next time the UE connects to a legitimate cell site.

At step 402, the PLMN receives the metrics from the UE indicating a connection to the PSAP failed. The PLMN may determine, at step 404, a probability score for a cell site corresponding to the metrics. For example, the metrics may indicate the signal strength between the UE and the cell site. Based on the signal strength, the PLMN may determine the probability score. The PLMN may also consider metrics received from other UEs in proximity to determine the probability score. Accordingly, based on the probability score, at step 406, the PLMN may determine the cell site is fraudulent.

In some aspects, at step 408, the PLMN updates a forbidden network list with the cell site. The forbidden network list may be communicated, at step 410, to the UE and other UEs in proximity to the UE.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 5, a block diagram of an exemplary computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 5 are shown in the singular, they may be plural. For example, the computing device 500 might include multiple processors or multiple radios. In aspects, the computing device 500 may be a UE/WCD, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 510 that directly or indirectly couples various components together, including memory 512, processor(s) 514, presentation component(s) 516 (if applicable), radio(s) 524, input/output (I/O) port(s) 518, input/output (I/O) component(s) 520, and power supply(s) 522. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 512 may take the form of memory components described herein. Thus, further elaboration will not be provided here, but it should be noted that memory 512 may include any type of tangible medium that is capable of storing information, such as a database. A database may be any collection of records, data, and/or information. In one embodiment, memory 512 may include a set of embodied computer-executable instructions that, when executed, facilitate various functions or elements disclosed herein. These embodied instructions will variously be referred to as “instructions” or an “application” for short.

Processor 514 may actually be multiple processors that receive instructions and process them accordingly. Presentation component 516 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A method for automatic public land mobile network (PLMN) serving system reselection based on E911 public safety answer point (PSAP) termination failures, the method comprising:
attempting, at a user equipment (UE), a connection to the PSAP;
receiving, at the UE, an indication the connection to the PSAP failed;
based on the indication, communicating metrics to the PLMN, the metrics corresponding to a cell site providing service to the UE while the UE attempted the connection to the PSAP.

2. The method of claim 1, further comprising attempting, at the UE, additional connections to the PSAP until a threshold number of failed connections is reached.

3. The method of claim 1, further comprising inferring, at the UE, the cell site is fraudulent.

4. The method of claim 3, further comprising providing, by the UE, a peer-to-peer communication to other UEs in proximity to the UE indicating the cell site is fraudulent.

5. The method of claim 1, wherein the peer-to-peer communication adds the cell site to a forbidden network list stored at the subscriber identity module (SIM) card corresponding to each of the other UEs.

6. The method of claim 1, further comprising receiving, at the UE, a forbidden network list indicating the cell site is fraudulent.

7. The method of claim 6, further comprising storing, at a subscriber identity module (SIM) card associated with the UE, the forbidden network list.

8. The method of claim 1, wherein the metrics include received signal strength indicator (RSSI) values.

9. A method for automatic public land mobile network (PLMN) serving system reselection based on E911 public safety answer point (PSAP) termination failures, the method comprising:
receiving, at the PLMN, metrics from a user equipment (UE) indicating a connection to PSAP failed, the metrics corresponding to a cell site providing service to the UE while the UE attempted the connection to the PSAP;
determining, at the PLMN, a probability score for the cell site corresponding to the metrics; and
based on the probability score, determining the cell site is fraudulent.

10. The method of claim 9, further comprising updating a forbidden network list with the cell site.

11. The method of claim 10, further comprising communicating the forbidden network list to the UE and to other UEs in proximity to the UE.

12. The method of claim 11, wherein the forbidden network list is stored on a subscriber identity module (SIM) card associated with the UE and the other UEs.

13. The method of claim 9, wherein the metrics include received signal strength indicator (RSSI) values.

14. A system for automatic public land mobile network (PLMN) serving system reselection based on E911 public safety answer point (PSAP) termination failures, the system comprising:
a node configured to wirelessly communicate with user equipment (UE); and
the UE configured to:
(1) attempt a connection to the PSAP;
(2) receive an indication the connection to the PSAP failed;
(3) based on the indication, communicate metrics to the PLMN, the metrics corresponding to a cell site providing service to the UE while the UE attempted the connection to the PSAP.

15. The system of claim 14, further comprising attempting, at the UE, additional connections to the PSAP until a threshold number of failed connections is reached.

16. The system of claim 15, further comprising inferring, at the UE, the cell site is fraudulent.

17. The system of claim 14, further comprising providing, by the UE, a peer-to-peer communication to other UEs in proximity to the UE indicating the cell site is fraudulent, wherein the peer-to-peer communication adds the cell site to a forbidden network list stored at the subscriber identity module (SIM) card corresponding to each of the other UEs.

18. The system of claim 14, further comprising receiving, at the UE, a forbidden network list indicating the cell site is fraudulent.

19. The system of claim 18, further comprising storing, at a subscriber identity module (SIM) card associated with the UE, the forbidden network list.

20. The system of claim 14, wherein the metrics include received signal strength indicator (RSSI) values.
